(19) United States
(12) Patent Application Publication
(10) Pub. No.: US 2007/0013349 A1
(43) Pub. Date: Jan. 18, 2007

(54) Zero voltage switching buck converter

(76) Inventor: John A. Bassett, San Ramon, CA (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/487,709

(22) Filed: Jul. 17, 2006

Related U.S. Application Data
(60) Provisional application No. 60/700,164, filed on Jul. 18, 2005.

(51) Int. Cl. G05F 1/00

(52) U.S. Cl. 323/222

(57) ABSTRACT

The present invention is directed generally to a buck converter that achieves zero voltage switching (ZVS). According to various embodiments, the buck converter comprises a ZVS circuit for storing reverse recovery current from the diode of the buck converter and using the energy from the reverse recovery current to discharge parasitic capacitance of the primary switch of the buck converter prior to turn-on of the primary switch such that the primary switch turns on with substantially zero voltage across the switch. The ZVS circuit may comprise a capacitor, an auxiliary switch connected in series with the capacitor, and an auxiliary inductor connected in parallel with the series-connected capacitor and auxiliary switch. The control circuit controls the primary switch and the auxiliary switch of the ZVS circuit such that (i) the auxiliary switch and the primary switch are not both on at the same time, and (ii) there is a time interval between the end of the on-time of the auxiliary switch and the beginning of the on-time of the primary switch. The time interval (which may be a fixed duration) is of sufficient duration such that the energy from the reverse recovery current substantially discharges the parasitic capacitance of the primary switch during the time interval. Interleaved embodiments of the buck converter are also disclosed.

### CROSS-REFERENCE TO RELATED APPLICATION

The present application claims priority to U.S. provisional application Ser. No. 60/700,164, filed Jul. 18, 2005, entitled “Zero Voltage Switching Buck Converter” by John A. Bassett, which is incorporated herein by reference.

### BACKGROUND

The present invention generally concerns electronic power processing circuits.

A block diagram of a conventional power supply 10 is shown in FIG. 1. An AC input is converted to a DC voltage by a rectifier bridge 12. The rectified DC voltage is supplied to a boost converter 14 that provides power factor correction. To perform power factor correction, the voltage must be boosted to above the highest peak input voltage expected during use. For a power supply 10 capable of operating at a 230 Vac input, which is the typical mains voltage in Europe and Asia, a voltage of 400 V at the output of the boost converter 14 is often selected to be higher than the peak of the 230 Vac input when it increases to its maximum tolerance.

The DC/DC converter 16 converts the high DC output voltage of the boost converter 14 to a regulated output voltage for powering a load 18. In many applications, the DC/DC converter 16 may contain multiple (such as two) DC/DC conversion stages. The first stage often includes a buck (or step-down) converter 20 and the second stage often includes an unregulated DC/DC conversion stage, such as a so-called DC transformer 22. A diagram of a conventional buck converter 20 is shown in FIG. 2. When the primary switch 30 is closed (referred to as the “on-time”), the input voltage (Vin) is connected to the inductor 32. This voltage will tend to cause the current in the inductor 32 to rise. The diode 34 is back biased during the on-time. When the switch 30 is turned off, the inductor current will continue flowing, such that the energy stored in the core of the inductor 32 during the on-time can supply the load's energy requirements. During the off-time, the inductor current flows through the load and, with the primary switch 30 open, through the diode 34. The output voltage (Vout) is held relatively constant by the presence of the capacitor 36. The on-times and off-times of the primary switch 30 are controlled by a control circuit 38 to achieve a desired output voltage.

It is also known to interleave two (or more) buck converters. Among other things, interleaved buck converters provide the advantage of reduced ripple at the output as the ripples from the respective converters cancel each other.

There is a continuing trend toward miniaturization in electronics and DC/DC converters can be made physically smaller when operated at higher frequencies. This is because smaller components can be used at higher frequencies. Operating at higher frequencies, however, can cause substantial switching losses due to energy stored in the junction of the semiconductor switches, such as the primary switch 30. These switching losses reduce efficiency and generate heat, which must be effectively managed to maintain reliability. As the trend towards more efficient and smaller electronic devices continues, there accordingly exists a need for more efficient, smaller DC/DC converters.

### SUMMARY

In one general aspect, the present invention is directed to a buck converter that achieves zero voltage switching (ZVS). According to various embodiments, the buck converter includes a ZVS circuit for storing reverse recovery current from the diode of the buck converter and using that energy to discharge the parasitic capacitance of the primary switch of the buck converter prior to turn-on of the primary switch such that the primary switch turns on with substantially zero voltage across the switch. In various implementations, the ZVS circuit includes a capacitor, an auxiliary switch connected in series with the capacitor, and an auxiliary inductor connected in parallel with the series-connected capacitor and auxiliary switch. The ZVS circuit may be connected in series with either the diode of the buck converter or in series with the primary switch.

The control circuit may control the primary switch and the auxiliary switch of the ZVS circuit such that (i) the auxiliary switch and the primary switch are not both on at the same time, and (ii) there is a time interval between the end of the on-time of the auxiliary switch and the beginning of the on-time of the primary switch. The time interval (which may be a fixed duration) may be of a sufficient duration such that the energy from the reverse recovery current is capable of substantially discharging the parasitic capacitance of the primary switch during the time interval. Interleaved embodiments of the buck converter are also disclosed.

The present invention, in certain embodiments thereof, provides the advantage of reduced switching losses due to the ZVS operation. This increases converter efficiency and allows smaller components to be used. Also, the present invention, in various embodiments, obviates the need for expensive zero-reverse-recovery Silicon Carbide diodes. These and other benefits of the present invention will be apparent from the description to follow.

### DESCRIPTION OF THE FIGURES

Various embodiments of the present invention are described herein by way of example in conjunction with the following figures, wherein:

FIG. 1 is a block diagram of a conventional power supply;

FIG. 2 is a diagram of a convention buck converter;

FIG. 3 is a diagram of a ZVS buck converter according to various embodiments of the present invention;

FIG. 4 is a diagram illustrating the idealized switch-timing for the buck converter of FIG. 3 according to various embodiments of the present invention;

FIGS. 5 and 6 are diagrams of a ZVS buck converter according to various other embodiments of the present invention; and

FIG. 7 is a block diagram of a power supply including a ZVS buck converter to various embodiments of the present invention.

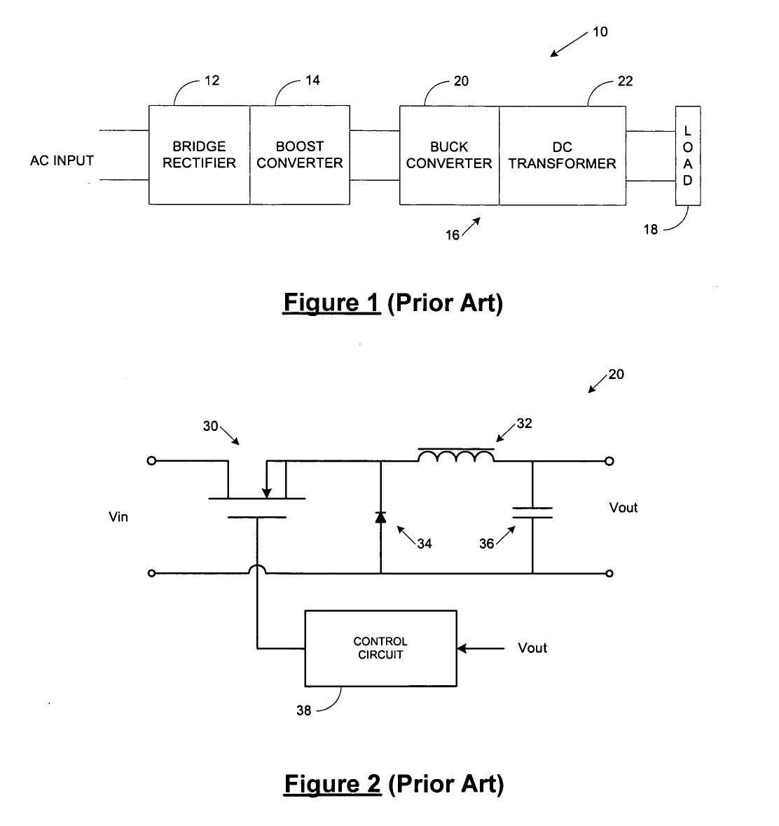

### DETAILED DESCRIPTION

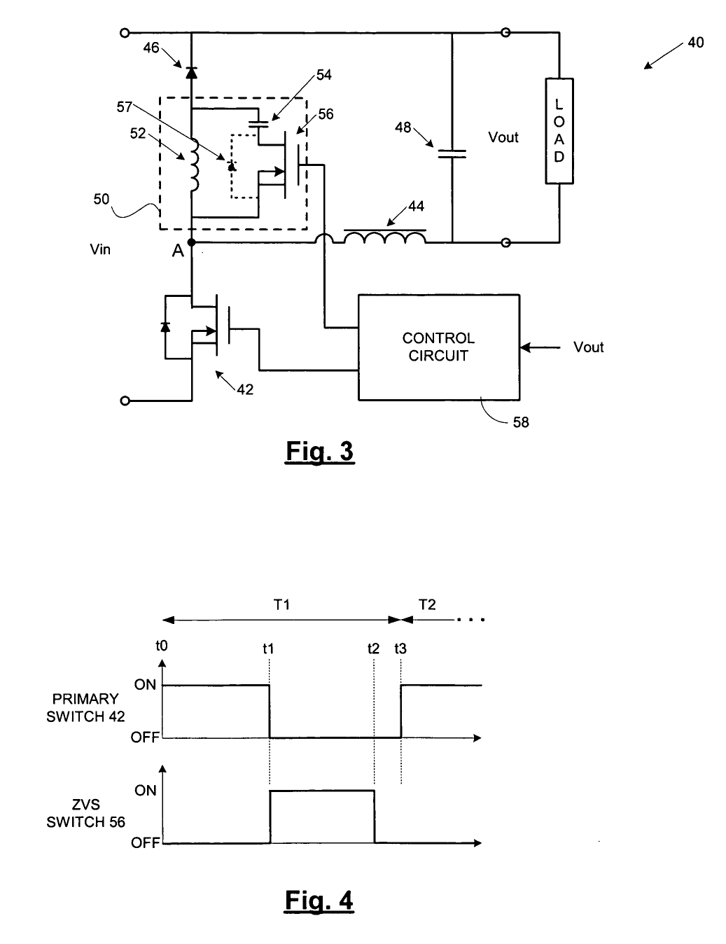

FIG. 3 is a diagram of a buck converter 40 according to various embodiments of the present invention. Like a conventional buck converter, the buck converter 40 of FIG. 3 includes a primary switch 42, an inductor 44, a diode 46 and an output capacitor 48. A control circuit 58 controls the duty cycle ratio of the primary switch 42 based on feedback regarding the output voltage (Vout) to achieve a desired output voltage. Unlike conventional buck converters, the buck converter 40 of FIG. 3 includes a zero-voltage switching (ZVS) circuit 50. The ZVS circuit includes a ZVS (or auxiliary) inductor 52, a ZVS (or auxiliary) capacitor 54 and a ZVS (or auxiliary) switch 56. The ZVS circuit 50 is connected in series with the diode 46 in the embodiment of FIG. 3 and, as explained below, discharges the parasitic capacitance of the primary switch 42 such that the primary power switch 42 can turn on with substantially zero volts across the switch 42. As used herein, the term “zero voltage switching” (or “ZVS”) implies that at least 75% of the voltage across the primary switch 42 has been discharged. Because the dissipated energy resulting from turn-on of a semiconductor switch is related to the square of the voltage across the switch, a reduction in the voltage across the primary switch 42 of 75% translates to an energy savings of approximately 94%.

The primary switch 42 and the ZVS switch 56 may be semiconductor switches, and are preferably MOSFETs, as shown in FIG. 3. As used herein, a semiconductor switch is “on” or “closed” when it is in a low-impedance state, and such a switch is “off” or “open” when it is in a high-impedance state. Also, the diode 46 preferably has a non-zero reverse recovery time such that reverse recovery current can flow in the diode 46, which obviates the need to use more expensive, zero reverse recovery Silicon Carbide diodes.

The switch-timing architecture of the switches 42, 56 is shown in FIG. 4, where the period of the switching cycle of the primary switch 42 is assumed to be T. In the first cycle, T1, the primary switch 42 is turned on at time t0 and remains on until time t1, when the control circuit 58 turns it off. During the on-time of the primary switch 42 (i.e., t0 to t1), the ZVS switch 56 is off. During this portion of the cycle, the inductor 44 is connected to the input voltage (Vin), causing the current in the inductor 44 to increase. The diode 46 is also reverse or back biased during this interval, but due to the non-zero recovery time of the diode 46, some reverse recovery current flows from the cathode to the anode of the diode 46 at the start of the on-time of the primary switch 42. This current is transferred from the ZVS inductor 52 to the ZVS capacitor 54 via the intrinsic body diode 57 of the ZVS switch 56 or a discrete diode connected across the ZVS switch 56.

At time t1, the primary switch 42 is turned off and the ZVS switch 56 is turned on. The current in the inductor 44 now flows forward through the forward-biased diode 46 and the ZVS inductor 52. Also, the ZVS capacitor 54, having the energy from the reverse recovery current stored thereon, discharges through the now-turned-on ZVS switch 56, superimposing this energy on the load current flowing through the ZVS inductor 52.

At time t2, the control circuit 58 opens the ZVS switch 56. The primary switch 42 is also still open at this time in the cycle such that both switches 42, 56 are off during this portion of the cycle (t2-t3). During this time period, the current in the ZVS inductor 52 is greater than the current in the inductor 44 due to the reverse recovery diode current that was stored in the ZVS circuit 50 at the beginning of the on-time of the primary switch 42. The opening of the ZVS switch 56 at t2 causes the parasitic capacitance across the primary switch 42 to be discharged during the dead time interval (t2 to t3) as the ZVS inductor 52 will draw the additional energy from the parasitic capacitance from the primary switch 42 to maintain its increased current level in comparison with the inductor 44. Thus, at time t3, the voltage at node A (e.g., the drain terminal of the primary switch 42) will be approximately zero such that the primary switch 42 may be turned on by the control circuit 58 at t3 with substantially zero volts across the switch 42 at the start of the next switching cycle (T2) of the converter 40. The energy in the parasitic capacitance of the primary switch 42 will, therefore, be returned to the input instead of being dissipated as heat. This, in turn, reduces the size of the heat sink needed for the primary switch 42 or entirely eliminates the need for such a heat sink in some applications. Also, ZVS permits the use of a physically smaller primary switch 42 and increases the efficiency of the converter 40.

According to various embodiments, while the control circuit 58 may modulate the on-time of the primary switch 42 to achieve the desired load voltage, the duty cycle of the ZVS switch 56 may be fixed. The dead time (t2-t3) when both switches 42, 56 are off is preferably sufficiently long to substantially discharge the parasitic capacitance across the primary switch 42 such that zero voltage switching is achieved. That is, the dead time is sufficiently long such that the voltage at node A decreases to approximately zero by time t3. Consequently, the diode 46 preferably permits sufficient recovery current to store enough inductive energy in the ZVS circuit 50 to discharge the parasitic capacitance of the primary switch 42. According to various embodiments, the inductance of the ZVS inductor 52 may be, for example, 10 μH and the capacitance of the ZVS capacitor 54 may be, for example, 2 μF. Also, the dead time interval (t2-t3) may be, for example, fifty (50) to one hundred (100) nanoseconds. That is, the control circuit 58 may turn off the ZVS switch 56 fifty (50) to one hundred (100) nanoseconds before the control circuit 58 turns on the primary switch 42. Also, although not shown in the timing diagram of FIG. 4, there is preferably a dead time between the end of the on-time of the primary switch 42 and the beginning of the on-time of the ZVS switch 56 to prevent cross-conduction. The control circuit 58 may be implemented with a commercially available IC controller.

At a 50% duty cycle, the ZVS operation is independent of the load, but as the duty cycle increases at a constant load current, ZVS and its concomitant benefits are lost. For a 2:1 buck converter, the converter typically only operates at high duty cycles during the short hold-up times. Also, where the buck converter 40 is used to down-convert the output of a PFC boost converter, resulting in wide-ranging duty cycles, the downside of lost ZVS operation at high duty cycles is mitigated by the fact that the current goes to zero at maximum duty cycle.

The control circuit 58 can directly drive the primary switch 42, although the control circuit 58 is preferably transformer-coupled to the control (gate) terminal of the ZVS switch 56. However, in embodiments where the on-time of the ZVS switch 56 is short and constant, the transformer coupling circuit (not shown) is not difficult to implement.

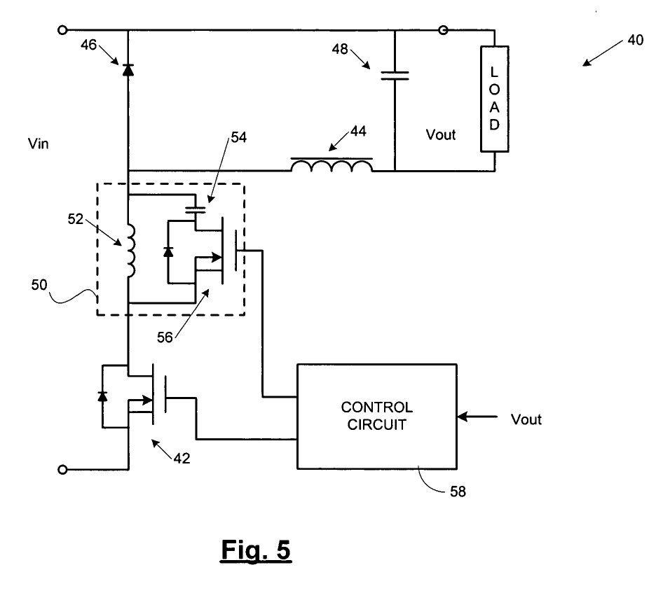

According to another embodiment, the ZVS circuit 50 may be connected in series with the primary switch 42 rather than the diode 46, as shown in FIG. 5. In this embodiment, the ZVS inductor 52 sees the load current (i.e., the current through the inductor 44) during the on-time of the primary switch 42, not during the off-time as in the embodiment of FIG. 3.

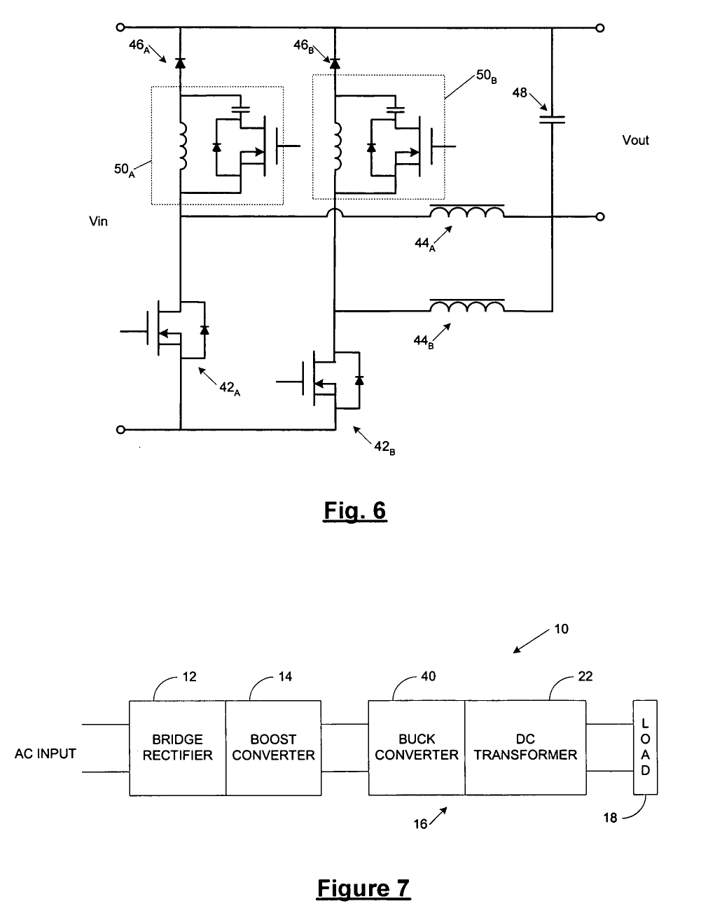

According to other embodiments, a number (N) of such ZVS buck converters 40 may be interleaved with each such buck converter 40 operating 360/N degrees apart. For example, as shown in FIG. 6, a first buck converter comprising inductor 44_{A}, diode 46_{A}, primary switch 42_{A}, and ZVS circuit 50_{A} may be interleaved with a second buck converter comprising inductor 44_{B}, diode 46_{B}, primary switch 42_{B}, and ZVS circuit 50_{B}. In such an embodiment, the primary switch 42_{A} is operated 180 degrees out of phase with the primary switch 42_{B}. Similarly, the switches of the ZVS circuits 50_{A, B} are operated 180 degrees out of phase. The outputs from the two converters are coupled together to supply the load, which is connected across the common output capacitor 48. Such an interleaved arrangement reduces output ripple. For simplicity, the control circuit is not shown in FIG. 6.

According to other embodiments, one of the buck converters 40 described above may be used in an AC/DC power supply, as shown in FIG. 7. The buck converter 40 in the power supply 10 of FIG. 7 may be, for example, an interleaved buck converter such as shown in FIG. 6.

Although the present invention has been described herein with respect to certain embodiments, those of ordinary skill in the art will recognize that many modifications and variations of the present invention may be implemented. For example, there may be additional windings magnetically coupled to the inductor 44. Also, any of the semiconductor switches described herein may be implemented as a single semiconductor switch or a number of semiconductor switches connected in parallel. The foregoing description and the following claims are intended to cover all such modifications and variations.

What is claimed is:

1. A DC/DC converter for converting an input voltage to an output voltage, comprising:
a buck converter including a primary switch, a diode and an inductor, such that when the primary switch is on the inductor is connected to the input voltage and when the primary switch is off the inductor is disconnected from the input voltage;
a control circuit for periodically turning on and off the primary switch; and
a ZVS circuit for storing reverse recovery current from the diode of the buck converter and using energy from the reverse recovery current to discharge parasitic capacitance of the primary switch of the buck converter prior to turn-on of the primary switch such that the primary switch turns on with substantially zero voltage across the primary switch.

2. The DC/DC converter of claim 1, wherein the ZVS circuit comprises:
a capacitor;
an auxiliary switch connected in series with the capacitor; and
an auxiliary inductor connected in parallel with the series-connected capacitor and auxiliary switch.

3. The DC/DC converter of claim 1, wherein the control circuit is for controlling the auxiliary switch such that:
the auxiliary switch and the primary switch are not both on at the same time; and
there is a time interval between the end of the on-time of the auxiliary switch and the beginning of the on-time of the primary switch, wherein the time interval is of sufficient duration such that the energy from the reverse recovery current substantially discharges the parasitic capacitance of the primary switch during the time interval.

4. The DC/DC converter of claim 3, wherein the ZVS circuit is connected in series with the diode of the buck converter.

5. The DC/DC converter of claim 3, wherein the ZVS circuit is converter is connected in series with the primary switch.

6. The DC/DC converter of claim 3, wherein the time interval is of a fixed duration.

7. The DC/DC converter of claim 6, wherein the ZVS circuit is connected in series with the diode of the buck converter.

8. The DC/DC converter of claim 6, wherein the ZVS circuit is converter is connected in series with the primary switch.

9. The DC/DC converter of claim 1, further comprising:
a second buck converter connected in parallel with the buck converter, the second buck converter including a second primary switch, a second diode and a second inductor, such that when the second primary switch is on the second inductor is connected to the input voltage and when the second primary switch is off the second inductor is disconnected from the input voltage; and
a second ZVS circuit for storing reverse recovery current from the second diode of the second buck converter and using energy from the reverse recovery current to discharge parasitic capacitance of the second primary switch of the second buck converter prior to turn-on of the second primary switch such that the second primary switch turns on with substantially zero voltage across the second primary switch.

10. The DC/DC converter of claim 9, wherein the control circuit operates the second primary switch of the second buck converter 180 degrees out of phase with the primary switch of the buck converter.

11. The DC/DC converter of claim 1, wherein the diode of the buck converter has a non-zero reverse recovery time.

12. The DC/DC converter of claim 3, wherein the ZVS circuit further comprises an auxiliary diode connected across the auxiliary switch.

13. A DC/DC converter for converting an input voltage to an output voltage, comprising:
a buck converter including a primary switch, a diode and an inductor, such that when the primary switch is on the inductor is connected to the input voltage and when the primary switch is off the inductor is disconnected from the input voltage;
a ZVS circuit for storing reverse recovery current from the diode of the buck converter and using energy from the reverse recovery current to discharge parasitic capacitance of the primary switch of the buck converter prior to turn-on of the primary switch such that the primary switch turns on with substantially zero voltage across the primary switch, wherein the ZVS circuit comprises:
a capacitor;
an auxiliary switch connected in series with the capacitor; and
an auxiliary inductor connected in parallel with the series-connected capacitor and auxiliary switch; and
a control circuit for periodically turning on and off the primary switch such that:
the auxiliary switch and the primary switch are not both on at the same time; and
there is a time interval between the end of the on-time of the auxiliary switch and the beginning of the on-time of the primary switch, wherein the time interval is of sufficient duration such that the energy from the reverse recovery current substantially discharges the parasitic capacitance of the primary switch during the time interval.

14. The DC/DC converter of claim 13, wherein the ZVS circuit is connected in series with the diode of the buck converter.

15. The DC/DC converter of claim 13, wherein the ZVS circuit is converter is connected in series with the primary switch.

16. The DC/DC converter of claim 13, wherein the time interval is of a fixed duration.

17. An AC/DC converter for converting an AC input voltage to a DC output voltage for powering a load, the AC/DC comprising:
a bridge rectifier for rectifying the AC input voltage;
a boost converter coupled to the bridge rectifier; and
a DC/DC converter coupled to the output of the boost converter, wherein the DC/DC converter comprises at least one buck converter stage, wherein the at least one buck converter stage comprises:
a buck converter including a primary switch, a diode and an inductor, such that when the primary switch is on the inductor is connected to the input voltage and when the primary switch is off the inductor is disconnected from the input voltage;
a control circuit for periodically turning on and off the primary switch; and
a ZVS circuit for storing reverse recovery current from the diode of the buck converter and using energy from the reverse recovery current to discharge parasitic capacitance of the primary switch of the buck converter prior to turn-on of the primary switch such that the primary switch turns on with substantially zero voltage across the primary switch.

18. The AC/DC converter of claim 17, wherein the ZVS circuit of the buck converter stage comprises:
a capacitor;
an auxiliary switch connected in series with the capacitor; and
an auxiliary inductor connected in parallel with the series-connected capacitor and auxiliary switch.

19. The AC/DC converter of claim 18, wherein the control circuit of the buck converter stage is for controlling the auxiliary switch such that:
the auxiliary switch and the primary switch are not both on at the same time; and
there is a time interval between the end of the on-time of the auxiliary switch and the beginning of the on-time of the primary switch, wherein the time interval is of sufficient duration such that the energy from the reverse recovery current substantially discharges the parasitic capacitance of the primary switch during the time interval.

20. The AC/DC converter of claim 19, wherein the ZVS circuit is connected in series with the diode of the buck converter.

21. The AC/DC converter of claim 19, wherein the ZVS circuit is converter is connected in series with the primary switch.

22. The AC/DC converter of claim 19, wherein the time interval is of a fixed duration.
